(19) United States
(12) Patent Application Publication
(10) Pub. No.: US 2014/0121821 A1
(43) Pub. Date: May 1, 2014

(54) SYSTEM AND METHOD FOR DETERMINING POSITION IN A MULTIPLE-AXIS MACHINE

(71) Applicant: GM GLOBAL TECHNOLOGY OPERATIONS LLC, Detroit, MI (US)

(72) Inventors: Jie Gu, Clarkston, MI (US); David Miral, Commerce Township, MI (US)

(73) Assignee: GM GLOBAL TECHNOLOGY OPERATIONS LLC, Detroit, MI (US)

(21) Appl. No.: 13/661,660

(22) Filed: Oct. 26, 2012

(51) Int. Cl. G06F 19/00

(52) U.S. Cl. 700/186

(57) ABSTRACT

In a machine comprising a spindle configured for performing a machine process in positional relation to a table, a method of operating the machine comprises fixing a probe to the spindle and fixing an object to the table. A first orientation position of the object relative to the spindle is determined while the table is positioned in a first table orientation. The table is re-oriented to a second table orientation, and a second orientation position of the object relative to the spindle is determined. A position of a table reference point along a first direction relative to the spindle is determined by averaging the first orientation position and the second orientation position, and a position of the spindle relative to the table is adjusted based on the position of a table reference point along the first direction.

### FIELD OF THE INVENTION

The subject invention relates to automated machines for manufacturing components and more particularly to systems and methods for recalibrating manufacturing machines based on determinations of relative locations of components of a machine.

### BACKGROUND

In today's world, machines are used to perform many automated processes. For example, machines may be used to automatically mill or etch work-pieces made of materials such as metal, plastics or wood. Machines may also be used to apply coatings to various work-pieces, to weld work-pieces together, to measure attributes of work-pieces, or to join work-pieces so as to produce an assembly. Typically, one component of a machine (i.e., the passive component) (e.g., a clamp or a fixture) serves to control the position of a work-piece while another component of the machine (i.e., the active component) (e.g., a tool, arm, applicator, laser, spray nozzle, or spindle) facilitates performance of one or more operations or processes on the work-piece. Such machines, therefore, may control the positional relationship between the active component and the passive component, and thus between the active component and the work-piece. By controlling the positional relationship between the components, the process may be performed at desired locations on the work-piece.

Common machine tools may be classified according to the number of degrees of freedom in which the machine and/or work-piece may be manipulated during the machining process. For example, a four-degree machine may facilitate translation in each of the three axes in addition to rotation about one of the axes. Such machines are capable of controlling the positional relationships between their active and passive components throughout their range of motion in any one, or any combination, of the degrees of freedom.

During such machine processes, it can be very important that the positional relationships be controlled with precision and consistency. Accordingly, movements of the active component must be precisely and consistently coordinated with the relative location and physical geometry of the work-piece being processed. Unfortunately, however, as processed work-pieces are loaded to a fixture, unloaded from the fixture, and replaced with on or in the fixture by other pre-processed work-pieces, variations in location and/or physical geometries can be introduced. For example, foreign objects can become lodged, inconsistently, between a work-piece and the fixture holding the work-piece in place for processing. Also, dimensional deviations between work-pieces can introduce further variation in the performance of the machining process. Still further, machine table position may drift during operation with the drifting error causing further quality issues. These variations must be accounted and compensated by the machine apparatus/method in order to maintain control over positional relationships and thereby reduce potential quality issues in finished products.

To address these issues, workers may periodically perform calibration operations on machines. Unfortunately, conventional table position corrections can be time-consuming and labor intensive. For example, to recalibrate one exemplary four-degree machine requires a skilled worker must climb into the machine chamber, place a tooling bar into the spindle of the machine, and record the relative positions of the tooling bar while positioning the fixture/table at a number of orientations relative to the tooling bar (e.g., at 0, 90 and 180 degrees of relative rotation). Once the measurements are complete, the worker may calculate a table center error based on the measurements and implement a correction (e.g., manual adjustment of the machine or entry of a correction parameter into the control software for the machine). Then, the worker may need to reboot the machine. This process must typically be repeated every time the machine requires recalibration.

Regardless how often a worker may seek to recalibrate the machine, due to measurement errors inherent in the indication procedure, a residual error may result. Such errors may be due to roundness errors associated with the measurement tool and deflection of the tool. To address these issues, calibration of the probe may be periodically performed, requiring use of an accurate calibration instrument that is independent of the probe.

Accordingly, it is desirable to have an improved system and method for determining a position of a work-piece for a machine process.

### SUMMARY OF THE INVENTION

In one exemplary embodiment of the invention, a method for operating a rotary table machine that includes a spindle configured for performing a machine process in positional relation to a table is provided. The exemplary method comprises fixing a probe to the spindle and loading an object to a fixture positioned on the table. A first orientation position of the object relative to the spindle is determined while the table is positioned in a first table orientation. The table is re-oriented to a second table orientation, and a second orientation position of the object relative to the spindle is determined. A position of a table reference point along a first direction relative to the spindle is determined by averaging the first orientation position and the second orientation position, and a position of the spindle relative to the table is adjusted based on the position of a table reference point along the first direction.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic drawing showing an exemplary rotary table machine for performing a machine-implemented process;

FIG. 2 is a schematic drawing showing portions of an exemplary rotary table machine with an object installed to a table of the machine;

FIG. 3 is a flowchart showing an exemplary method for determining a position of the table reference point along a first direction;

FIG. 4 is a schematic drawing showing portions of an exemplary rotary table machine with a fixture installed to a table of the machine;

FIG. 5 is a flowchart showing an exemplary method for determining a fixture position offset relative to a table reference point;

FIG. 6 is a schematic drawing showing portions of an exemplary rotary table machine with a fixture installed to a table of the machine; and

FIG. 7 is a schematic drawing showing portions of an exemplary rotary table machine with a fixture installed to a table of the machine.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

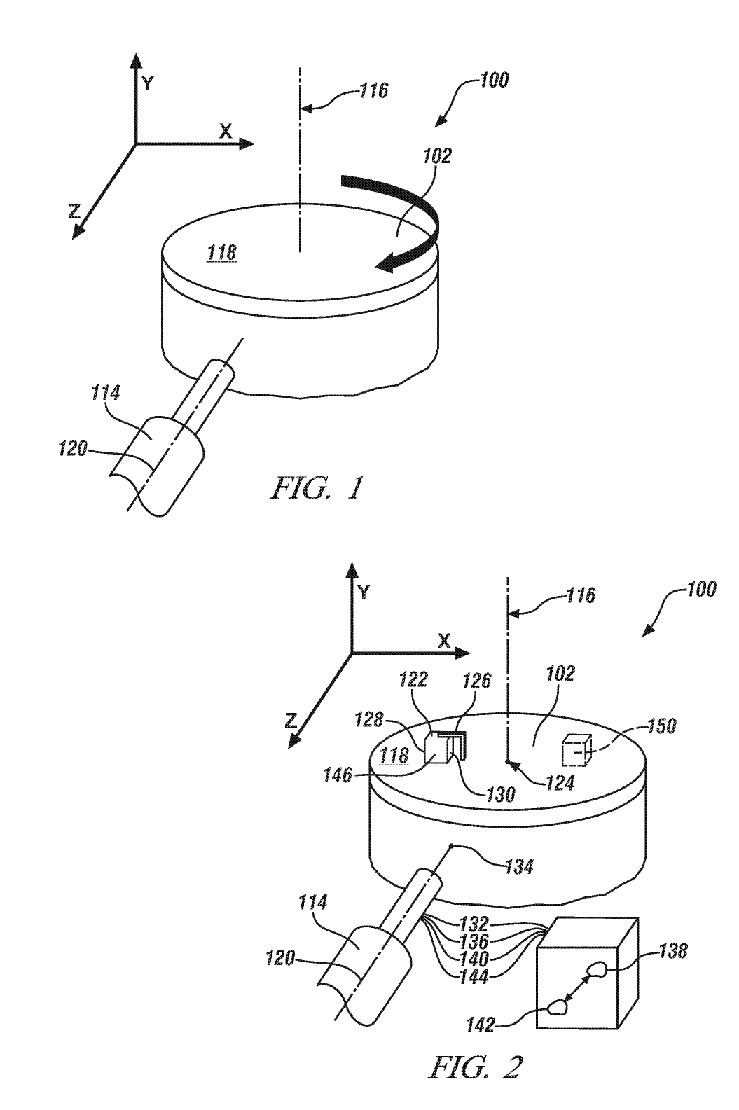

In accordance with an exemplary embodiment of the invention, FIG. 1 and FIG. 2 show an exemplary four-degree rotary table machine 100 (e.g., a CNC milling machine) for performing a machine-implemented process on a work-piece (not shown in FIG. 1). The machine 100 includes a table 102 and a spindle 114. A fixture 126 (FIG. 2) is installed to the table 102 and is configured for selectively fixing and releasing a work-piece in a desired position and orientation, or in a series of desired positions and orientations, relative to the spindle 114, while the spindle 114 and the table 102 (together with the fixture 126) cooperate to facilitate performance of the machine-implemented process on the work-piece.

In an exemplary embodiment, the work-piece is a metal casting such as an engine block or a cylinder head, and the machine-implemented process is a milling process in which material from the metal casting is removed (e.g., boring of a cylinder, machining of an intake port). It should be appreciated, however, that the work-piece may be any piece to be subjected to a machine-implemented process. It should also be appreciated that the machine-implemented process may be any process susceptible to machine implementation and performable on the selected work-piece.

As shown in FIG. 1, the table 102 and the spindle 114 are arranged in close proximity to one another and coupled for coordinated movement relative to one another in three dimensions (i.e., along a combination of three orthogonal axes X, Y, and Z). The spindle 114 defines a spindle axis 120 (e.g., the longitudinal axis of the spindle 114), about which the spindle 114 is configured for rotating. The table 102 provides a work surface 118, and, for convenience, the Y-axis is defined as being orthogonal to the work surface 118, which may be entirely or partially planar. Accordingly, at least a portion of the work surface 118 is parallel (i.e., tangential) to both the X-axis and the Z-axis.

In the embodiment shown in FIG. 1, the table 102 defines a work surface 118, which is planar, and to which the fixture 126 is installed. The table 102 is also configured for re-orientation relative to a table axis 116 that is parallel to the Y-axis. In operation, an orientation of the table is set relative to the spindle 114 at a first table orientation defined as 0 degrees and at a second table orientation being 180 degrees of rotation about the Y-axis relative to the first table orientation. In performance of a machine-implemented process, it is necessary or desirable to know relative position information of a work-piece installed to the table 102. This relative position information may be deduced by first determining a table reference location, through which the table axis 116 passes, and about which the table 102 rotates as it is re-oriented, and then determining a fixture position offset representing a distance between the fixture and the table reference location. The relative position information may be used to facilitate recalibration of the machine-implemented process and to enable the process to be performed with improved precision at desired locations of a work-piece installed to the table 102.

As shown in FIG. 2, an object 122 having parallel sides (e.g., a cube) is clamped or otherwise installed to the table 102, preferably in a position reasonably close to a table reference point 124, which corresponds to the intersection of the table axis 116 and the work surface 118. As mentioned above, for convenience, the Y-axis is defined as being orthogonal to at least a portion of the work surface 118. Accordingly, both the X-axis and the Z-axis are parallel to that portion of the work surface 118 with both the X-axis and the Z-axis being parallel to a pair of sides of the object 122. In one exemplary embodiment, the object 122 is permanently installed to the table 102. In another exemplary embodiment, the object 122 is periodically installed or affixed to the table 102 with a fixture 126 (which may comprise a releasable clamp assembly) and subsequently removed from the table 102 for convenience. In both cases, the object 122 defines a first object side surface 128 and a second object side surface 130, with both the first object side surface 128 and the second object side surface 130 being arranged parallel to the YZ-plane.

When the table 102 occupies a first table orientation, a centroid position of the object 122 along the X-axis (i.e., a first orientation position 146) is defined by the object 122 along the X-axis, between the first object side surface 128 and the second object side surface 130, so as to occupy a fixed position with respect the table.

With the object 122 arranged as described above, a probe 134 is affixed to the spindle 114. The probe 134 is configured for detecting a physical location of an object (e.g., a first object side surface 128 or a second object side surface 130 of object 122) contacting or nearly contacting the probe 134. In one embodiment, probe 134 is configured for detecting when an object 122 is in sufficiently close proximity to probe 134 that contact or near contact between the probe 134 and either a first object side surface 128 or second object side surface 130 of the object 122 may be deduced. As those skilled in the art will appreciate, a Hall effect sensor may be used to enable a proximity version of probe 134 while a Renishaw probe or a Blum probe may be used for embodiments of probe 134 where actual contact with object 122 is desirable.

When the probe 134 is in actual contact with the object 122 (as in embodiments using a Renishaw or Blum contacting probe), or is in sufficiently close proximity to the object (as in embodiments using a Hall effect proximity probe), a position of the spindle 114 (or other structure attached to the spindle 114) may be recorded, providing position information for the probe 134. The position information acquired for the probe 134 when the probe 134 is in contact or near contact with the first object side surface 128 or the second object side surface 130 of the object 122 corresponds to the position of the first object side surface 128 or the second object side surface 130 of the object 122. The position information may then be transmitted to a processor for retention in a data storage location, such as in a memory module 138 of an associated machine controller 142, and for subsequent retrieval and use in performing recalibration operations on the machine 100 or making adjustments to machining operations performed by the machine 100.

Once the probe 134 has been used to determine and store location information for either the first object side surface 128 or the second object side surface 130 of the object 122, the probe 134 may be used to determine and store location information for the other of the first object side surface 128 or the second object side surface 130 of the object 122. Prior to obtaining the data for the second of the two surfaces, however, the spindle 114 is rotated 180 degrees about the spindle axis 120. As a result of the rotation of the probe 134, there is no need to calibrate the probe 134 to compensate for roundness errors associated with the probe 134 or deflection of the probe 134 or run-out, stem deflection, stylus radius error associated with the probe 134. It should be noted that by rotating the spindle, the error inherent in a pre-rotation reading is equal to and opposite of the error in the post-rotation reading. As a result, any errors inherent in the probe are cancelled when the readings containing equal and opposite error terms are added (e.g., averaged).

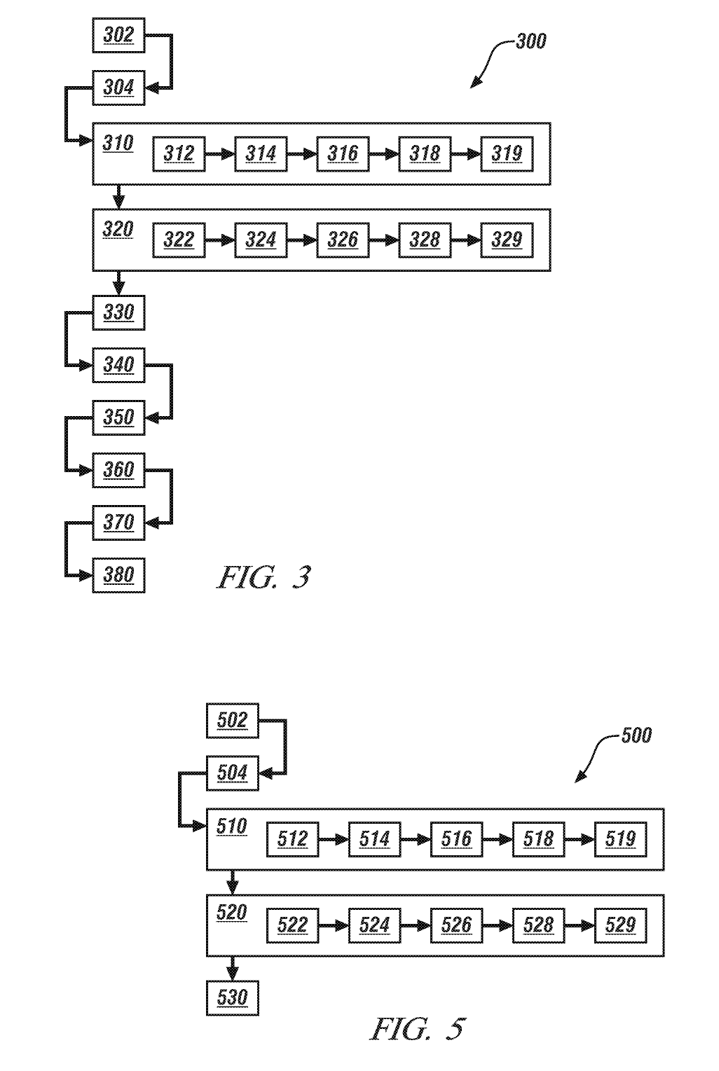

Accordingly, as shown in FIG. 3, an exemplary method 300 for operating a rotary table machine, based on simple, yet reliable determination of the position of the table reference point 124 along a first direction (e.g., along the X-axis), includes fixing a probe 134 to the spindle 114 (step 302) and fixing an object 122 that defines a first object side surface 128 and a second object side surface 130 to the table 102 with both the first object side surface 128 and the second object side surface 130 being arranged parallel to the YZ-plane (i.e., perpendicular to the X-axis) (step 304). When the table 102 occupies a first table orientation, a centroid position of the object 122 (corresponding to a first orientation position 146 of the object 122) is determined (step 310), and a second orientation position 150 of the object 122 (representing new location of the center of the object 122 along the X-axis) is determined at a second table orientation (e.g., approximately 180 degrees from the first table orientation) of the table 102 (step 320). Based on the first orientation position 146 and the second orientation position 150, the location of reference point 124, which corresponds to the intersection of the table axis 116 and the work surface 118, along the X-axis, is calculated (step 330).

In an exemplary embodiment, the step of determining a first orientation position 146 of the object 122 at a first table orientation (step 310) comprises positioning the table 102 in a first table orientation (step 312). One of the first object side surface 128 and the second object side surface 130 is probed while a first orientation first side position signal 132 is collected, transmitted as necessary, and stored in memory (step 314). Next, the spindle 114 is rotated 180 degrees about the spindle axis 120 (step 316). Then, the other of the first object side surface 128 and the second object side surface 130 is probed while a first orientation second side position signal 136 is collected, transmitted as necessary, and stored in memory (step 318). Then, the first orientation position 146 of the object 122 at the first table orientation is calculated (step 319) by averaging the first orientation first side position signal 132 and the first orientation second side position signal 136.

In an exemplary embodiment, the step of determining a second orientation position 150 of the object 122 at a second table orientation (step 320) comprises re-orienting the table 102 180 degrees (i.e., one half revolution) about the table axis 116 (step 322). Then, one of the first object side surface 128 and the second object side surface 130 is probed while a second orientation first side position signal 140 is collected, transmitted as necessary, and stored in memory (step 324). Then, the spindle 114 is rotated 180 degrees about the spindle axis 120 (step 326). Next, the other of the first object side surface 128 and the second object side surface 130 is probed while a second orientation second side position signal 144 is collected, transmitted, and stored in memory (step 328). Then, the second orientation position 150 of the object 122 at the second table orientation is calculated (step 329) by averaging the second orientation first side position signal 140 and the second orientation second side position signal 144.

In an exemplary embodiment, the location of reference point 124, which corresponds to the intersection of the table axis 116 and the work surface 118, along the X-axis, is calculated (step 330) as the average of the first orientation position 146 and the second orientation position 150. Based on the location of the table reference point 124 along the X-axis direction, a position of the spindle 114 may be adjusted relative to the table 102 to provide further processing of work-pieces with improved accuracy and reliability.

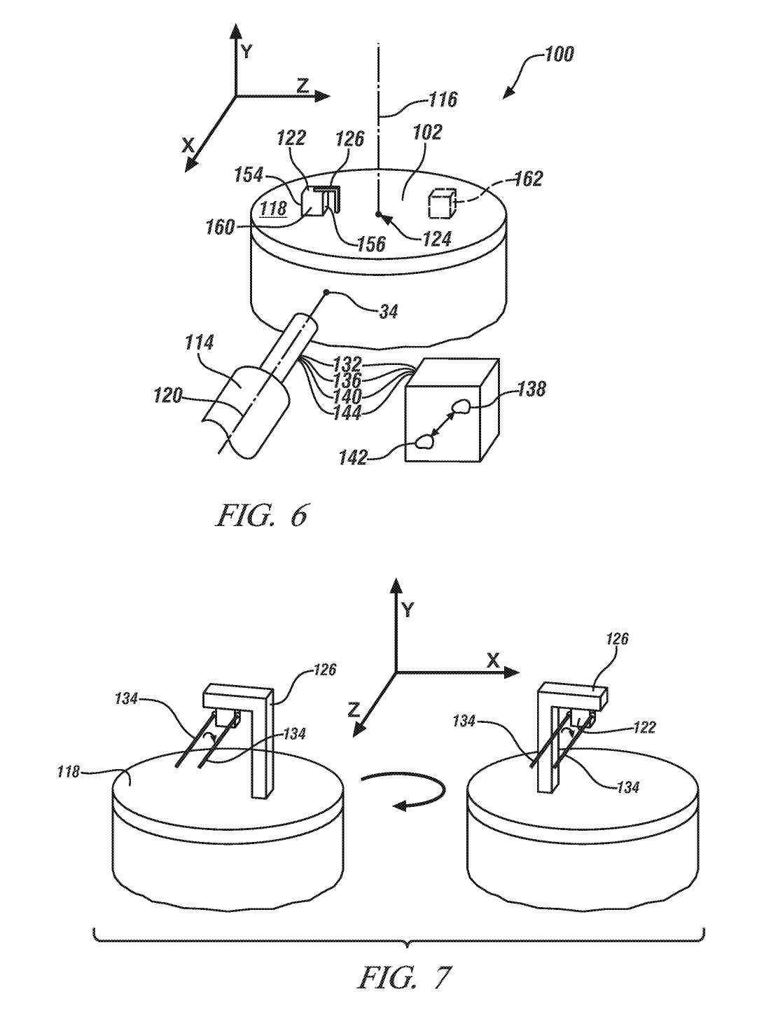

As shown in FIG. 6, where a spindle 114 is available to be positioned and oriented along an axis perpendicular to the Z-axis (i.e., along the X-axis), the position of the table reference point 124 along a second direction (e.g., along the Z-axis) may be determined (step 340) by fixing an object 122 that defines a third object side surface 154 and a fourth object side surface 156 to the table 102 with both the third object side surface 154 and the fourth object side surface 156 being arranged parallel to the YX-plane (i.e., perpendicular to the Z-axis) (step 350). A third orientation position 160 of the object 122 (representing location of the center of the object 122 along the Z-axis) is determined at a third table orientation (step 360), and a fourth orientation position 162 of the object 122 (representing new location of the center of the object 122 along the Z-axis) is determined at a fourth table orientation of the table 102 (step 370).

In an exemplary embodiment, the step of determining a third orientation position of the object (step 360) includes positioning the table in the third table orientation while probing one of the third object side surface and the fourth object side surface to produce a third orientation third side position. Then, the spindle is rotated approximately 180 degrees about a spindle axis and the other of the third object side surface and the fourth object side surface is probed to produce a third orientation fourth side position. Finally, the third orientation third side position and the third orientation fourth side position are averaged to produce the third orientation position 160 of the object.

In an exemplary embodiment, the step of determining a fourth orientation position of the object (step 370) includes positioning the table in the fourth table orientation while probing one of the third object side surface and the fourth object side surface to produce a fourth orientation third side position. Then the spindle is rotated approximately 180 degrees about a spindle axis, and the other of the third object side surface and the fourth object side surface to produce a fourth orientation fourth side position. The fourth orientation third side position and the fourth orientation fourth side position are averaged to produce the fourth orientation position 162 of the object.

Based on the third orientation position 160 and the fourth orientation position 162, the location of reference point 124, which corresponds to the intersection of the table axis 116 and the work surface 118, along the Z-axis, is calculated (step 380). Based on the location of the table reference point 124 along the Z-axis direction, a position of the spindle 114 may be adjusted relative to the table 102 to provide further processing of work-pieces with improved accuracy and reliability.

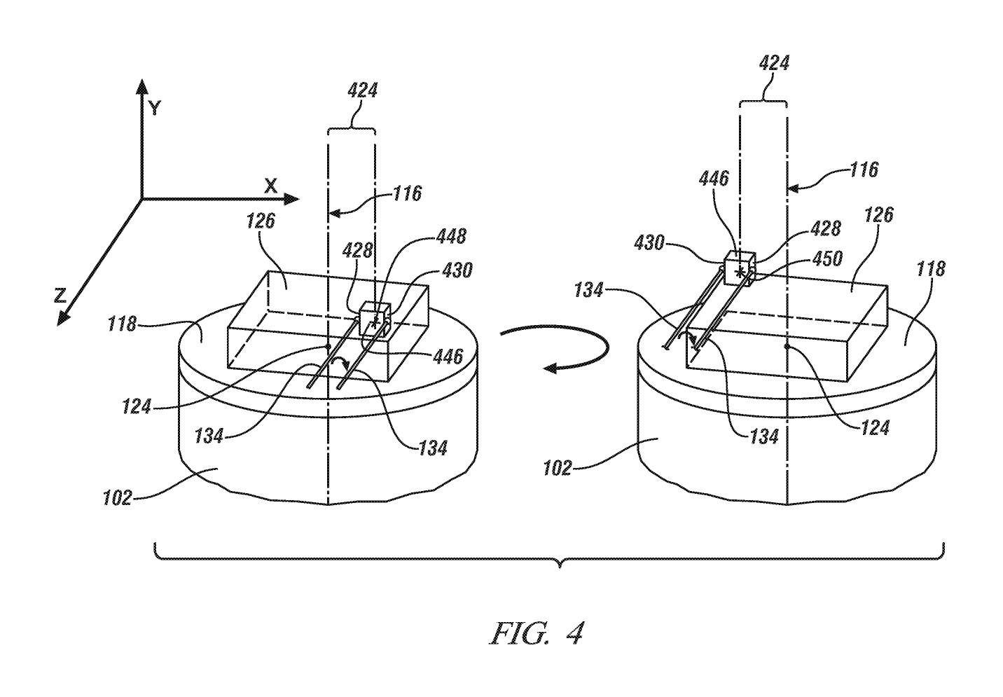

As shown in FIG. 4 and FIG. 7, a fixture 126 is clamped, fixed, or otherwise installed to the table 102, typically a finite distance from the table reference point 124 (i.e., the intersection of the table axis 116 and the work surface 118) so as to occupy a fixed position with respect the table 102. The fixture 126 defines a first fixture side 428 and a second fixture side 430, with both the first fixture side 428 and the second fixture side 430 being arranged generally parallel to (or tangential to) the YZ-plane. A fixture centroid position 446 of the fixture 126 is positioned along the X-axis between the first fixture side 428 and the second fixture side 430.

With the fixture 126 arranged as described above, the probe 134 may be used to determine and store location information for either the first fixture side 428 or the second fixture side 430 of the fixture 126. Then, the spindle 114 (FIG. 1) is rotated 180 degrees about the spindle axis 120 (FIG. 1), and the probe 134 is used to determine and store location information for the other of the first fixture side 428 or the second fixture side 430 of the fixture 126. The fixture centroid position 446 (i.e., a fixture position offset 424) of the fixture 126 is determined by averaging the difference between the location of the first fixture side 428 and the location of the second fixture side relative to the table reference point 124.

Accordingly, as shown in FIG. 5, an exemplary method 500 for determining a fixture position offset 424 relative to the table reference point 124 along a first direction (e.g., along the X-axis) includes fixing a probe 134 to the spindle 114 (step 502) and installing a fixture 126 that defines a first fixture side 428 and a second fixture side 430 to the table 102 with both the first fixture side 428 and the second fixture side 430 being arranged parallel (or tangential) to the YZ-plane (i.e., perpendicular, at least locally, to the X-axis) (step 504). A first orientation position of the fixture 126 (representing location of the center of the fixture 126 along the X-axis) is determined at a first table orientation (step 510), and a second orientation position of the fixture 126 (representing new location of the center of the fixture 126 along the X-axis) is determined at a second table orientation of the table 102 (step 520). Based on the first orientation position 448 and the second orientation position 450, a position representing the location of fixture 126 is calculated (step 530) as half of the difference between the first orientation position 448 and the second orientation position 450.

In an exemplary embodiment, the step of determining a first orientation fixture position of the fixture 126 at a first table orientation (step 510) comprises positioning the table 102 in a first table orientation (step 512). One of the first fixture side 428 and the second fixture side 430 is probed while a first orientation first fixture side position is collected, transmitted as necessary, and stored in memory (step 514). Next, the spindle 114 is rotated 180 degrees about the spindle axis 120 (step 516). Then, the other of the first fixture side 428 and the second fixture side 430 is probed while a first orientation second fixture side position is collected, transmitted as necessary, and stored in memory (step 518). Then, the first orientation fixture position of the fixture 126 at the first table orientation is calculated (step 519) by averaging the first orientation first fixture side position and the first orientation second fixture side position.

In an exemplary embodiment, the step of determining a second orientation fixture position of the fixture 126 at a second table orientation (step 520) comprises re-orienting the table 102 180 degrees (i.e., one half revolution) about the table axis 116 (step 522). Then, one of the first fixture side 428 and the second fixture side 430 is probed while a second orientation first fixture side position is collected, transmitted as necessary, and stored in memory (step 524). Then, the spindle 114 is rotated 180 degrees about the spindle axis 120 (step 526). Next, the other of the first fixture side 428 and the second fixture side 430 is probed while a second orientation second fixture side position is collected, transmitted, and stored in memory (step 528). Then, the second orientation position of the fixture 126 at the second table orientation is calculated (step 529) as half of the difference between the first orientation position and the second orientation position.

In an exemplary embodiment, a location of fixture 126 relative to the reference point 124 is calculated (step 530) as the average of the first orientation fixture position and the second orientation fixture position. With the table center being known, and with the offset of the fixture being known, the precise location of the work-piece can also be known such that processes can be performed on the work-piece with precision.

During production, a position of an exemplary table 102 may drift gradually, at a relatively slow rate. Accordingly, it may not be necessary to perform a process for determining the position of the table reference point 124 following every operation of the machine 100. An exemplary schedule may depend upon machining volume, for example, comprising a once per day frequency probe for heavy machining volume, a once per week frequency for a light machining volume, and a once probe once every month if the machine is very stable. In an exemplary embodiment, the exemplary method 300 of determining the position of the table reference point 124 is scheduled for re-execution at regular time intervals (e.g., during periodic shut-downs of the machine 100). In addition, an exemplary method 300 of determining the position of the table reference point 124 is scheduled for re-execution upon the occurrence of one or more predetermined criteria, such as accumulated manufacturing cycles or signs of excessive variations in dimensions of the machine or work-pieces processed by the machine. The predetermined criteria and the prescribed scheduling may be based on accumulated experience for drift in the machine apparatus or processed work-pieces. In an exemplary embodiment, identifying the location of the fixture center is performed more frequently.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method for operating a rotary table machine that includes a spindle configured for performing a machine process in positional relation to a table configured for rotation about a table axis, comprising:
fixing a probe to the spindle;
fixing an object to a work surface of the table, determining a first orientation position of the object relative to the spindle while the table is positioned in a first table orientation;
re-orienting the table approximately 180 degrees about the table axis from the first table orientation to a second table orientation;
determining a second orientation position of the object relative to the spindle while the table is positioned in the second table orientation;
determining a position of a table reference point along a first direction relative to the spindle by averaging the first orientation position and the second orientation position, the table reference point corresponding to an intersection of the table axis and the work surface; and
adjusting a position of the spindle relative to the table based on the position of a table reference point along the first direction.

2. A method for operating a rotary table machine as described in claim 1, wherein the object defines a first object side surface and a second object side surface, and wherein the first object side surface and the second object side surface are arranged substantially tangential to a second direction that is orthogonal to the first direction.

3. A method for operating a rotary table machine as described in claim 2, wherein determining a first orientation position of the object relative to the spindle comprises:
positioning the table in the first table orientation while probing one of the first object side surface and the second object side surface to produce a first orientation first side position;
rotating the spindle approximately 180 degrees about a spindle axis;
probing the other of the first object side surface and the second object side surface to produce a first orientation second side position; and
averaging the first orientation first side position and the first orientation second side position to produce the first orientation position of the object relative to the spindle.

4. A method for operating a rotary table machine as described in claim 3, further comprising collecting, transmitting, or storing the first orientation first side position.

5. A method for operating a rotary table machine as described in claim 3, further comprising collecting, transmitting, or storing the first orientation second side position.

6. A method for operating a rotary table machine as described in claim 2, wherein determining a second orientation position of the object relative to the spindle comprises:
positioning the table in the second table orientation while probing one of the first object side surface and the second object side surface to produce a second orientation first side position;
rotating the spindle approximately 180 degrees about a spindle axis;
probing the other of the first object side surface and the second object side surface to produce a second orientation second side position; and
averaging the second orientation first side position and the second orientation second side position to produce the second orientation position of the object relative to the spindle.

7. A method for operating a rotary table machine as described in claim 6, further comprising collecting, transmitting, or storing the second orientation first side position.

8. A method for operating a rotary table machine as described in claim 6, further comprising collecting, transmitting, or storing the second orientation second side position.

9. A method for operating a rotary table machine as described in claim 3, further comprising determining a position of the table reference point along the second direction.

10. A method for operating a rotary table machine as described in claim 1:
wherein the object defines a third object side surface and a fourth object side surface;
wherein the third object side surface and the fourth object side surface are arranged substantially tangential to a second direction that is orthogonal to the first direction; and
further comprising:
determining a third orientation position of the object relative to the spindle while the table is positioned in a third table orientation;
re-orienting the table approximately 180 degrees about a table axis from the third table orientation to a fourth table orientation;
determining a fourth orientation position of the object relative to the spindle while the table is positioned in the fourth table orientation;
determining a location of a table reference point along the second direction relative to the spindle by averaging the third orientation position and the fourth orientation position; and
adjusting a position of the spindle relative to the table based on the location of the table reference point along the second direction.

11. A method for operating a rotary table machine as described in claim 10, wherein determining a third orientation position of the object relative to the spindle comprises:
positioning the table in the third table orientation while probing one of the third object side surface and the fourth object side surface to produce a third orientation third side position;
rotating the spindle approximately 180 degrees about a spindle axis;
probing the other of the third object side surface and the fourth object side surface to produce a third orientation fourth side position; and
averaging the third orientation third side position and the third orientation fourth side position to produce the third orientation position of the object relative to the spindle.

12. A method for operating a rotary table machine as described in claim 11, wherein determining a fourth orientation position of the object relative to the spindle comprises:
positioning the table in the fourth table orientation while probing one of the third object side surface and the fourth object side surface to produce a fourth orientation third side position;
rotating the spindle approximately 180 degrees about a spindle axis;
probing the other of the third object side surface and the fourth object side surface to produce a fourth orientation fourth side position; and
averaging the fourth orientation third side position and the fourth orientation fourth side position to produce the fourth orientation position of the object relative to the spindle.

13. A method for operating a rotary table machine as described in claim 1, further comprising:
determining a fixture position offset relative to the table reference point along the first direction; and
adjusting a position of the spindle relative to the table based on the fixture position offset.

14. A method for operating a rotary table machine as described in claim 13, wherein determining a fixture position offset relative to the table reference point along the first direction comprises:
attaching a fixture to the table, the fixture defining a first fixture side and a second fixture side, both the first fixture side and the second fixture side being arranged parallel to a second direction that is perpendicular to the first direction;
determining a first orientation fixture position relative to the spindle while the table is positioned in a first table orientation;
re-orienting the table approximately 180 degrees about a table axis from the first table orientation to a second table orientation;
determining a second orientation fixture position relative to the spindle while the table is positioned in the second table orientation;
determining a position of the fixture along the first direction relative to the spindle by averaging the first orientation fixture position and the second orientation fixture position; and
determining the fixture position offset by subtracting the position of the table reference point along a first direction relative to the spindle from the position of the fixture along the first direction relative to the spindle.

15. A method for operating a rotary table machine as described in claim 14, wherein determining a first orientation fixture position relative to the spindle comprises:
positioning the table in the first table orientation while probing one of the first fixture side and the second fixture side to produce a first orientation first fixture side position;
rotating the spindle approximately 180 degrees about a spindle axis;
probing the other of the first fixture side and the second fixture side to produce a first orientation second fixture side position; and
averaging the first orientation first fixture side position and the first orientation second fixture side position to produce the first orientation fixture position relative to the spindle.

16. A method for operating a rotary table machine as described in claim 14, wherein determining a second orientation fixture position relative to the spindle comprises:
positioning the table in the second table orientation while probing one of the first fixture side and the second fixture side to produce a second orientation first fixture side position;
rotating the spindle approximately 180 degrees about a spindle axis;
probing the other of the first fixture side and the second fixture side to produce a second orientation second fixture side position; and
averaging the second orientation first fixture side position and the second orientation second fixture side position to produce the second orientation fixture position relative to the spindle.

17. A method for operating a rotary table machine as described in claim 3, wherein the spindle axis is oriented substantially perpendicular to the first direction.

18. A method for operating a rotary table machine as described in claim 1, wherein the spindle is configured for manipulating a tool in performance of a machine process performed upon a work-piece that occupies a fixed position with respect the table.

19. A method for operating a rotary table machine as described in claim 1, wherein determining a first orientation position of the object relative to the spindle is performed at least once per month.

20. A method for operating a rotary table machine as described in claim 1, wherein determining a first orientation position of the object relative to the spindle is performed upon an occurrence of a predetermined criteria.
